(19) United States
(12) Patent Application Publication
(10) Pub. No.: US 2017/0175703 A1
(43) Pub. Date: Jun. 22, 2017

(54) Apparatus For Converting Or Absorbing Energy From A Moving Body Of Water

(71) Applicant: MATHCLICK LIMITED, London (GB)

(72) Inventor: Michele Grassi, Forte dei Marmi (IT)

(21) Appl. No.: 15/323,518

(22) PCT Filed: Jul. 3, 2015
(86) PCT No.: PCT/GB2015/051951

§ 371 Date: Jan. 3, 2017

(30) Foreign Application Priority Data
Jul. 3, 2014 (GB) 1411908.5
Nov. 13, 2014 (GB) 1420209.7

(51) Int. Cl. F03B 13/26; F03B 13/14; F03B 13/12

(52) U.S. Cl. CPC F03B 13/26; F03B 13/12; F03B 13/14

(57) ABSTRACT

There is provided an apparatus for absorbing or converting energy from a moving body of water. The apparatus comprises an energy capture element (3) which, in use, moves in response to movement of the body of water in which the energy capture element (3) is placed, and an elongate guide element (1) defining a guide path along which the energy capture element (3) can move. The energy capture element (3) is a volume. In use, the energy capture element (3) and the guide element (1) are arranged so that the energy capture element (3) moves along the guide path in a substantially horizontal plane in response to differences in water pressure along a length of the energy capture element (3) parallel to the guide path and in response to movement of the body of water surrounding the energy capture element (3).

The present invention relates to an apparatus for converting or absorbing energy from a moving body of water. In particular, the present invention relates to an apparatus having an energy capture element which, in use, moves in response to movement of the body of water in which the energy capture element is placed, and an elongate guide element defining a guide path along which the energy capture element can move.

Embodiments of the invention can be used as wave or tidal energy convertors for converting the energy in waves or other moving bodies of water into usable energy, such as electricity. Embodiments of the present invention can also be used for coastal protection by extracting and converting energy from waves to reduce the energy imparted by the waves against the shore. Embodiments can also be used as underwater wave sensors or to generate waves in a tank or other body of water.

It is well known that the movement of bodies of water, such as movement due to waves or currents represents a vast energy resource and many inventions have been made with the aim of extracting energy from such movements.

In the context of offshore wave generator devices, some solutions been designed with the aim of exploiting the variation in the free surface of the water induced by waves. This poses significant threats related to the extreme loads on the structures once extreme surface events, such as storms, occur near the device.

It is also known to extract energy from pressure gradients in a column of water, rather than from variations at the surface of the body of water. For example, WO-A-2008/065684 describes a wave energy converter which is completely submerged during use and which exploits the pressure gradients inside the water column to produce electricity. However, these devices are not ideally suited for shallow water operation, since room is required below the device to enable it to move freely and adjust to the changing sea state, with an optimal depth that is usually around 50 metres or more.

Shallow water wave energy generation devices that use pressure gradients or surge motion are usually in the form of a hinged flap or fin. One such example is the Oyster device from Aquamarine Power. A further example is found in U.S. Pat. No. 8,614,520, which provides a submergible, sloped absorption barrier wave energy converter using a hinged flap. These types of devices can be subject to cost, survivability and efficiency limitations, and are typically of significant size (in excess of half a megawatt or more) to reduce the cost per kilowatt of power available. The presence of the hinged structure moreover imposes a minimum value on the operating depth of the water required to guarantee operation of the device. This is mainly due to the size of the device, which needs to be approximately as long as the average water depth. This depth must be at least 2-3 times the wave height of the waves which one wants to intercept, because for larger waves the device will rotate underwater during the excursion induced by the wave, and therefore it must be at least approximately 15-20 meters in oceanic conditions. Given their hinged working mechanism, the known devices will duck below waves which exceed the pre-determined effective run of approximately ½ to ⅓ of water depth. This limits the power which can be extracted from waves and can pose a survivability problem if during extreme waves the flap or fin is slammed on its end-of-run stops. These devices are furthermore significantly affected by extreme weather, due to the loads which get exerted on the hinge mechanism, and usually try to balance by passively ducking below larger waves or by reducing the surface exposed to the wave.

In a further example, AU-A1-2013201756 describes a wave energy converter in which a vertically oriented panel is held within a vertically oriented slide frame connected to horizontal guide rails. Wave action against the panel drives the panel and the slide frame horizontally along the guide rails. When the water motion changes direction, the panel is moved up within the slide frame so that it is out of the water and both are returned to the start position. The wave intercepting component of this device is therefore moved at different depths during the wave motion. This motion in the water column exposes the wave intercepting component to potentially extreme stress in conditions where the wave is not perfectly predictable (which are the most common ones). This device moreover relies on thrust applied by a horizontally moving body of water and can only be used in shallow water.

In example US2010295302A1 the device has an energy extracting component which moves in a generally horizontal direction, but the device has no use in the extraction of energy from waves and works only for “unidirectional liquid flow”.

In example U.S. Pat. No. 7,476,986B1 the energy extraction component is a flat panel which, like the device disclosed in AU-A1-2013201756, extracts energy from wave flow. Wave action against the panel drives the panel and the shaft on which it is mounted towards a fixed housing. The panel inclination is then changed to reverse its motion with a reduced wave action on it. As with the device of AU-A1-2013201756, this device relies on thrust applied by a horizontally moving body of water.

Furthermore, effective wave energy convertors usually have no capacity to extract from tidal streams or currents, and are actually usually affected by these in a way which tends to interfere with wave energy absorption.

In the context energy extraction from currents (be it tidal stream, ocean current or river current or other similar situations), typical devices resemble horizontal axis turbines used for wind energy generation, where a propeller-like device is put in the stream. There are also some vertical axis turbine examples, and some fin-like structures although these designs are seldom used. These propeller based devices have blades which use the hydrofoil principle to generate lift and, from that, torque on the main rotor (which usually is either a central shaft of a peripheral ring). The rotor then couples with a power takeoff system, which is usually formed by a gearbox coupled to an electrical generator, by a direct drive generator or by an annular generator directly wound around the rotor. However, although this approach can be highly effective for wind energy generators, it is less effective for energy extraction from water. This is due to the fact that the hydrodynamic regime of water is different to that of air, and the consequent fact that gravity waves in water are also a significant energy vector not present in air. Additionally, the use of hydrofoils implies the use of delicate structures (the profiles which induce the hydrodynamic lift) which are prone to failure in very challenging environments (rivers and also, in some cases, in marine environments). Moreover, the nature of the intercepted flow must be within very stringent parameters in terms of laminarity and speed, since turbulence destroys lift and excessive speed generates forces which exceed the capability of the structures to withstand them. All this results in tidal or river flow turbines which are generally very expensive and complex, and limits the use of river turbines to only the very few rivers with a constant and smooth flow year round. Furthermore, tidal or flow turbines have usually no capacity to extract from waves.

In the context of coastal protection from waves (including storm waves and storm surges), the usual approach is through passive structures using their weight and shape to interfere with waves and reduce their energy. However, such structures can have a negative impact on the marine environment in which they are placed and can be unsightly.

It would be desirable to provide an energy conversion apparatus that overcomes at least some of the above limitations of known devices.

According to a first aspect of the present invention, there is provided an apparatus for absorbing or converting energy from a moving body of water, the apparatus comprising an energy capture element which, in use, moves in response to movement of the body of water in which the energy capture element is placed, and an elongate guide element defining a guide path along which the energy capture element can move, wherein the energy capture element is a volume and wherein, in use, the energy capture element and the guide element are arranged so that the energy capture element moves along the guide path in a substantially horizontal plane in response to differences in water pressure along a length of the energy capture element parallel to the guide path and in response to movement of the body of water surrounding the energy capture element.

By arranging the guide element so that the energy capture element moves along the guide path in a substantially horizontal plane, the energy capture element can be kept at a depth where wave energy is significant for all the run, thus having high capacity factor. This is contrary to structures hinged to the sea floor which rotate to deeper depth for geometrical reasons. For tidal extraction functionality, the possibility of keeping the energy capture element at a fixed depth is also important, contrary to blades in horizontal axis devices which move in different depths due to their size and are therefore to varying water speeds. The apparatus can also be kept always submerged at a predetermined distance from the average wave level, thus preserving it from excessive loads induced by waves and posing a reduced risk to surface vessels. For pure tidal-current extraction, the positioning can be made so as to optimize the efficiency (typically keeping the device towards the water surface) and for combined wave and tidal extraction an optimization can be made which allows the device to extract effectively and safely from both sources at the same time. This is contrary to wave extraction structures hinged to the sea floor which rotate in proximity to the surface during their rotation, or to horizontal axis tidal extraction ones which operate at different depths due to the large diameter of the blades.

As the energy capture element is a volume, as opposed to a flat plate arrangement, for example as shown in AU-A1-2013201756, the apparatus of the present invention can be more effectively moved along the guide path by differences in water pressure over the volume of the energy capture element, as well as by horizontal movement of the body of water. Consequently, the apparatus of the present invention is well suited for energy absorption or conversion from tidal movements and from wave motion in both shallow water and in deep water where the horizontal movement of the water may be minimal. This differs from known devices which rely either on the horizontal movement of the body of water or on the existence of pressure gradients in order to move the energy capture element, and not both. For example, the flat plate arrangements of AU-A1-2013201756 and U.S. Pat. No. 7,476,986B1, which are far less affected by pressure gradients in the water column induced by waves and rely instead on wave flow. Thus, the energy extraction efficiency of the apparatus of the present invention may be higher than that of known devices.

As a further advantage, the length of useful movement can be dimensioned to exceed the largest movement possibly induced by waves without having to build large structures, thus avoiding “end of run” loads which are at least one order of magnitude higher and much less predictable than those induced by pressure gradients. This is contrary to hinged structures where the run is related directly to the size of the fin or flap, so that to have a run of 10-15 meters the flap needs to be at least of that dimension. A long run allows also the machine to operate with currents, where present. For tides, the length of the run does not need to be tailored to the current regime, and the machine operates both in laminar and turbulent flows. The de-linking of apparatus size and wave height and current regime allows for the construction of arbitrarily small devices which preserve all the key features of larger ones and which can be shipped in standard shipping containers with minimal mounting activities required onsite. It also allows a standard size of machine to be shipped and deployed in different locations without the requirement for extensive wave and current site analysis. This is contrary to hinged structures which need to have at least one dimension that is in direct relationship to the wave dimensions and water depth at the installation site. For tidal and current applications, traditional devices need to be dimensioned according to the typical water speed.

Moreover, the substantially horizontal movement of the energy capture element results in far lower loading on any mooring system used to hold the apparatus in place. This means that the structure including the mooring can be small and light, without requiring the use of large surface boats or barges. This is in contrast to hinged structures in which very large loads and bending moments are induced in the mooring system.

Further advantages of the present invention include:
Due to a stroke length at nominal depth and without obstructions which can be sized to be longer than the longest movement induced by waves (for example, in oceanic conditions in excess of 20 m) and due to the fact that the distance from the water surface can be kept always positive, the apparatus is intrinsically safe and capable of resisting to even the largest waves.
The fact that the energy capture element can be kept always completely submerged eliminates any visual impact of the device.
Having the energy capture element guided in a generally horizontal path, the energy capture element can be made to maintain always a positive distance from the surface,
Due to the structure, in which the size of the power interceptor is not linked to the depth of the water, the simplicity of design and the avoidance of extreme loads which would be experienced if the wave or current power interceptor approached the surface, the devices based on the present invention can be scaled down to very reduced power levels (with no a priori limit on how small they can be) while keeping a competitive cost per kilowatt. This opens up the possibility of accessing even the consumer market, with 25 kW devices being developed based on the design, and even 1 kW power level or lower can be successfully implemented at a competitive cost.
The new devices based on the present invention have furthermore the advantage of being suitable for coastal protection from extreme weather, if used in a barrage configuration where several devices are places in sequence.
The devices can also be installed in rivers to work as current energy extractors
In locations where both waves and currents are present, the capacity factor of devices based on the present invention is intrinsically superior to that of devices which use only one of the sources to produce electricity.

In preferred embodiments, the energy capture element and the guide element are arranged so that the energy capture element remains completely submerged during use.

The apparatus may be arranged such that the depth of the guide path along which the energy capture element moves may be varied in response to changes in the sea state. This allows the operation of the energy capture element to be adapted to the conditions of the sea state or the speed of the current flow, thus improving the capacity factor of the apparatus and its survivability. Such a change, in response primarily to a change in the average wave height and less crucially by wave period and direction or to a change in current speed and less crucially by current direction, can be achieved by moving the guide element to a different depth, and/or by having a guide element that defines a guide path having different sections at different depths. In certain embodiments, the apparatus may be neutrally buoyant at the desired operating depth to allow the depth position of the apparatus to be maintained. Preferably, the apparatus further comprises a support structure to which the guide element is connected, the support structure being arranged to maintain a depth position and/or an orientation of the guide element in the body of water during use.

The support structure may be fixed in size and/or arrangement. Preferably, the support structure is adjustable to controllably vary a depth position and/or orientation of the guide element in the body of water during use.

Advantageously, altering the depth position of the guide element in the body of water allows the apparatus to be adapted to the energy of the sea state and/or to protect the device from hazards and/or to protect objects on the surface from the device. It may also allow the apparatus to be installed and subsequently maintained from the surface. This may avoid the need for scuba divers or underwater equipment, reduce installation and maintenance costs, and widen installation and maintenance weather windows.

Advantageously, altering the orientation of the guide element in the body of water allows the apparatus to be adapted to a different direction of the wave trains. This is especially advantageous in installations where the waves are not forced to move in a direction aligned with the depth gradient of the sea floor, for example not very close to shore, as efficiency can be maintained with changeable conditions.

The support structure may comprise any suitable arrangement. Preferably, the support structure comprises one or more legs for connecting the support structure to an anchor point, wherein the depth position and/or orientation of the guide element is defined by the length of the one or more legs.

As used herein, the term “anchor point” refers to any device to which the apparatus may be connected to maintain its position. This includes fixed anchors, such as seabed anchor points, and floating anchors, such as buoys or similar. It also includes any cable, rope, chain, or other connection means connected to a fixed and/or floating anchor to which the apparatus can be connected to in order to maintain its position.

As used herein, the term “leg” refers to any suitable elongate connector. This includes rigid legs, such as steel supports, or flexible legs, such as cables, chains, ropes, or similar, that extend between the apparatus and the anchor point to maintain the depth position and/or orientation of the guide element under tension.

The guide element may comprise any suitable structure. In certain preferred embodiments, the guide element comprises at least one beam or guide rail along which the energy capture element can move. In such embodiments, the at least one beam or guide rail may be fixed at each of its ends to the cross-element of respective substantially U-shaped support structures, wherein the legs of the support structures are fixable to either the bottom of the body of water in which, in use the apparatus is located or to a support surface which is, in use, fixable to mooring elements. The length of each of the legs of the respective support structures may be fixed. Alternatively, the length of each of the legs of the respective support structures can be controllably varied. In certain embodiments, the legs of the substantially U-shaped support structures are fixed to a support surface having, in use, controllable mooring elements to change the orientation of the support surface and hence the at least one beam or guide rail in the body of water in which it sits.

The guide path defined by the guide element may be substantially linear, to take into account that in a given sea state waves typically came from a fixed direction or at most from two, and that currents or tidal flows are also typically linear. This means that the guide path as a whole extends generally along a line and is not, for example, circular or convoluted. This includes but is not limited to a guide path that is a single substantially straight path, or which includes two or more substantially straight sections joined by one or more transition sections.

Alternatively, or in addition, the guide path defined by the guide element may be slightly curved in the horizontal and/or vertical planes. As used herein, the term “slightly curved” means that the guide path, or at least one section of the guide path, is curved with a radius of curvature which in a typical application will be of the same order of magnitude as the given portion of guide path.

Advantageously, this allows the movement of the energy capture element to be varied by the guide path. For example:
a) If the guide path is curved as to generate a “gravity potential well” in a certain location of the path (typically in the center of it), then the energy capture element will tend to go back to this position. The guide path can be either bent so that the two extremes are higher (with a negatively buoyant moving member) or the converse (with a positively buoyant moving member);
b) If the guide path is slightly curved in the horizontal plane, different sections of the guide path will be in slightly different directions. This allows for an adaptation of the general direction of movement of the energy capture element just keeping it in different regions of its path, without necessarily requiring the orientation of the guide element to be varied.

The guide path may have any suitable length. Preferably, the guide path is longer than the longest movement induced by waves. In certain embodiments, for example in oceanic conditions, the guide path has a length of at least 20 metres. Advantageously, this reduces the loading on the apparatus since the energy capture element is less likely to be slammed against the end of the guide path by the body of water. Thus, the apparatus should be capable of resisting even the largest of waves. In case the energy capture element reaches the end of the guide, the possibility of reducing its impact against the water via a rotation of the moving member, the opening of vents in it, a deflation of parts of it, any combination of the above or other methods which will be clear to the skilled person (typical of tidal applications of the machine) can help in reducing the force of impact. In certain embodiments, the guide path has a length of at least about 10 metres, preferably at least about 12 metres, more preferably at least about 20 metres.

The guide element may comprise any number or arrangement of tracks, rails, grooves, slots, or similar devices, or combinations thereof, to define the guide path. In certain preferred embodiments, the guide element comprises two or more substantially parallel tracks defining the guide path along which the energy capture element is arranged to move.

The guide path defined by the guide element may be substantially planar along its length. In such embodiments, when the guide element is arranged such that the guide path is substantially horizontal, the energy capture element will remain at substantially the same depth as it moves along the guide path. In certain preferred embodiments, the guide element may be arranged such that the guide path is divided along its length into two or more guide path sections that are collinear but vertically offset. In such embodiments, when the guide element is arranged such that the guide path is substantially horizontal, the depth position of the energy capture element can be adapted by moving the energy capture element between the guide path sections. This allows the operation of the energy capture element to be adapted to the conditions of the sea state or of the river flow, thus improving the capacity factor of the apparatus and its survivability.

The energy capture element and the guide element may be arranged so that the energy capture element moves along the guide path in a substantially horizontal direction that is transverse to the direction of movement of the body of water. For example, the energy capture element may be an airfoil that generates a lift force perpendicular to the flow of the body of water. In such examples, the energy capture element will reciprocate transverse to the movement of the body of water when the guide path defined by the guide element is oriented transverse to the movement of the body of water. Preferably, the energy capture element and the guide element are arranged so that the energy capture element moves along the guide path in a substantially horizontal direction having a component that is substantially perpendicular to the direction of movement of the body of water. This setup may be the preferred one in situations where there are both significant wave and tidal energy components, with the tidal one reasonably laminar especially when there are fewer waves. In certain preferred embodiments, the energy capture element and the guide element are arranged so that the energy capture element moves along the guide path in a substantially horizontal direction that is substantially parallel to the direction of movement of the body of water.

In preferred embodiments, the energy capture element is connected to the guide element such that, in use, the energy capture element moves along at least a section of the guide path at a substantially constant depth. With this arrangement, the energy capture element can be kept at a depth where wave energy is significant, thus allowing more efficient energy absorption or conversion. It also avoids exposing the apparatus to excessive loads induced by surface waves and potential problems caused by varying loads at different depths. It also allows the apparatus to remain entirely submerged during use, thus reducing the visual impact and the risk posed to surface vessels. Maintaining the energy capture element at a substantially constant depth reduces the exposure of the energy capture element to potentially extreme stress in conditions where the wave is not perfectly predictable (which are the most common ones), as may otherwise occur with devices in which the wave intercepting component is moved to different depths during the wave motion.

The energy capture element may be a streamlined body that generates a lift force in response to movement of the body of water to move the energy capture element along the guide path. Preferably, the energy capture element is a bluff body. That is, the drag force exerted on the energy capture element by movement of the body of water is dominated by pressure drag, rather than by friction drag. Unlike devices based on the hydrofoil principle, a system based also on drag and not exclusively on lift can be effective in extracting energy from a moving body of water without the need of being very large or having very high flow speed, contrary to what would happen in air. Systems which use drag can also be made such that they are generally sturdier and more resilient to extreme weather, and therefore more useful in difficult flow environments like rivers of tidal locations with extreme funnel effects. The substantially horizontal movement of the energy capture element and the reliance on drag also allows the arrangement of the present invention to efficiently absorb and convert energy from movement of a body of water due to both currents and from waves. Thus, the apparatus is more efficient than those extracting from only one source. The energy capture element may be arranged such that its movement in response to movement of the body of water is predominantly due to drag. The energy capture element may be arranged such that its movement in response to movement of the body of water is substantially entirely due to drag.

In preferred embodiments, there is no minimum volume for the energy capture element. Advantageously, very small machines can be built to extract effectively small amounts of energy from the waves and/or currents. In other embodiments the volume of the energy extraction element is at least about 1 metre cubed, or at least about 2 metres cubed.

The volume of the energy capture element is selected based on the peak power rating of the apparatus. This is because the force exerted on the energy capture element due to pressure gradients is dependent upon the volume of water displaced by the energy capture element. The peak power rating is a predetermined characteristic of the apparatus which depends on the structural and electrical components used in the apparatus. Preferably, the volume of the energy capture element in metres cubed is at least one fifth of the peak power rating of the apparatus in kilowatts. In other words, for an apparatus having a peak power rating of 20 kW, the volume of the energy capture element is preferably at least 4 metres cubed. The volume of the energy capture element in metres cubed may be greater than one fifth of the peak power rating of the apparatus in kilowatts, for example two fifths, three fifths or four fifths of the peak power rating of the apparatus in kilowatts. Volumes smaller than one fifth of the peak power would result in wave energy converters with very low ratio between average power and peak power, which in turn has been found to result in a very high cost compared to efficiency.

In a first example, the apparatus has a peak power rating of 5 kW and the energy capture apparatus has a volume of about 1 metre cubed. In a second example, the apparatus has a peak power rating of 10 kW and the energy capture apparatus has a volume of about 3 metres cubed.

The energy capture element may have any suitable length. Preferably, the energy capture element has a length in the direction of the guide path of at most half the smallest statistically significant wave. In certain embodiments, the energy capture element preferably has a length of at least 0.5 times its height and/or width. For example, the energy capture element may have a length of at least about 0.5 metres, about 1 metre, or about 2 metres.

The frontal area of the energy capture element, that is, the projected area of the energy capture element perpendicular to the direction of movement of the body of water, may be constant. This provides simplicity of operation. Preferably, the frontal area of the energy capture element can be controllably varied to vary the drag force exerted on the energy capture element by movement of the body of water. Advantageously, this allows the drag force exerted on the energy capture element to be reduced or increased as required. For example, it may be beneficial to reduce the drag force if the energy capture element is moving against the flow of water, or for reducing the operational loads on the apparatus. In such embodiments, the energy capture element may comprise one or more selectively inflatable parts that can be inflated by an inflator to increase the frontal area of the energy capture element and that can be deflated to decrease the frontal area of the energy capture element. Alternatively, or in addition, the energy capture element may comprise one or more selectively openable vents for varying the frontal area. For example, the energy capture element may comprise one or more apertures that can be selectively opened by moving one or more closing devices, such as flaps or sliding plates, to reduce the frontal area and reduce the drag exerted on the energy capture element by the body of water. Alternatively, or in addition, the energy capture element may comprise one or more moveable flaps for increasing the frontal area of the energy capture element, for example by extending the one or more flaps at the periphery of the energy capture element to extend its outer shape. Alternatively, or in addition, the energy capture element may be rotatable relative to the guide element to vary the frontal area. In such embodiments, the angle of attack of the energy capture element can be varied by rotating the energy capture element about one or more axes. For example, the energy capture element may be rotated about a vertical axis passing through its centre.

The energy capture element may be any suitable shape. For example, the energy capture element may have a parallelepiped, cylinder, or spherical shape. Alternatively, the energy capture element may be a flat plate.

The energy capture element may be a solid body. Alternatively, the energy capture element may be hollow. That is, the energy capture element may define one or more internal cavities. Preferably, the energy capture element defines a cavity within which the power converter is housed.

The power converter may comprise any suitable power take off system. For example, the power converter may comprise a belt and pulley system, where a belt is put into motion by the energy capture element to drive an electrical generator, or a rack and pinion system, where the rack is fixed relative to the guide element and the pinion is connected to an electrical generator fixed relative to the guide element. Alternatively, the power converter could comprise a power take off system based on maglev, or a magnetic dissipation device, such as the type employed to slow down some types of roller coaster.

The power converter may be arranged to convert energy from the movement of the energy capture element into any suitable form. In certain embodiments, the power converter may be arranged to convert energy extracted from the movement of the energy capture element along the guide path into electrical energy or electricity. For example, the power converter may comprise one or more electrical generators to convert the movement of the energy capture element along the guide path into electricity. This can then be transferred to a remote location (such as on land) via one or more electrical cables. Alternatively, the power converter could comprise a hydraulic pump to convert the reciprocating motion of the energy capture element into pressurization of water, which may then be used locally to generate electricity or transferred and used remotely (for example, on land) to generate electricity.

In alternative embodiments, the power converter may be arranged to dissipate or store energy extracted from the movement of the energy capture element along the guide path. For example, the power converter may comprise an electrical generator to convert the movement of the energy capture element along the guide path into electricity, which is dissipated as heat, or accumulated locally, for example by combining with a fuel cell producing chemicals from it and from the surrounding seawater and/or from a chemical precursor like ammonia or freshwater stored by the apparatus. Alternatively, or in addition, the power converter may comprise a friction generator that is arranged to extract and convert energy from the movement of the energy capture element along the guide path into heat, which can be dissipated.

Embodiments of the invention will now be described by way of non-limiting example with reference to the attached figures in which:

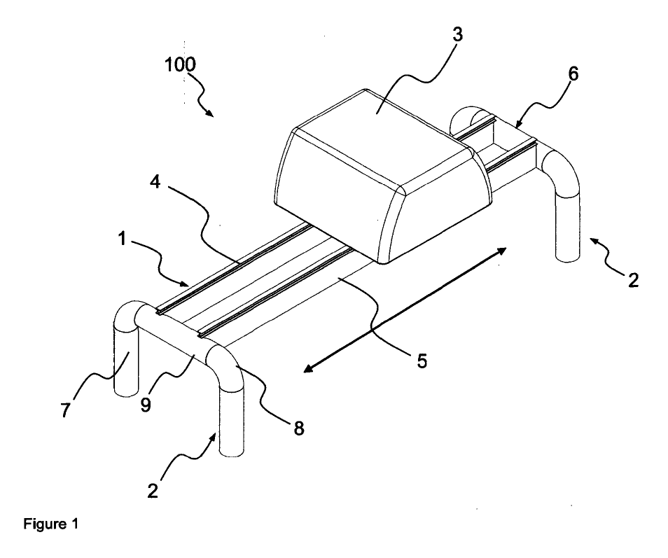

FIG. 1 illustrates a first embodiment of the invention;

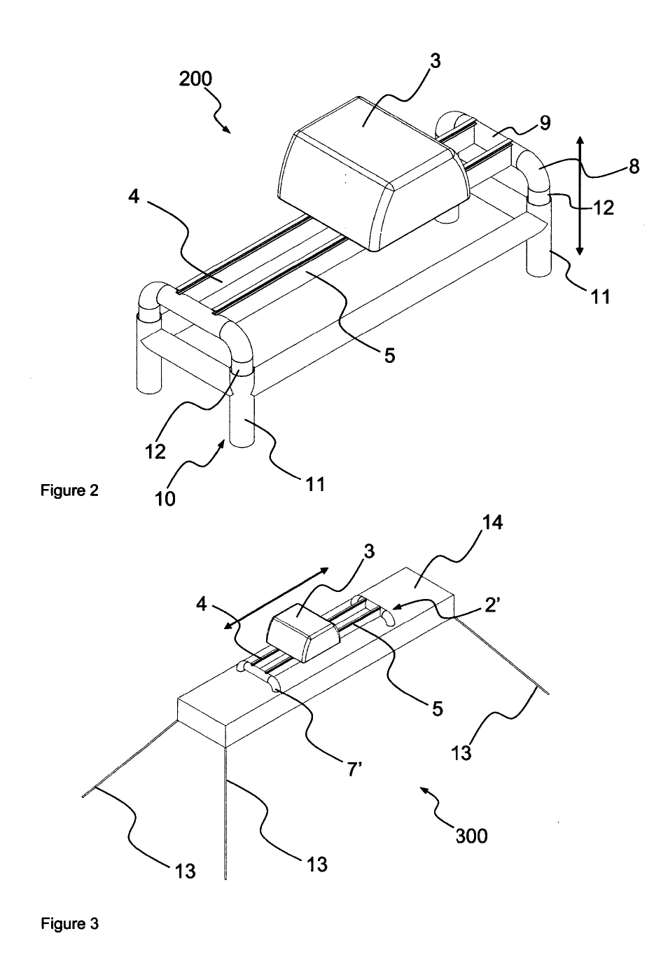

FIG. 2 illustrates a second embodiment of the invention;

FIG. 3 illustrates a third embodiment of the invention;

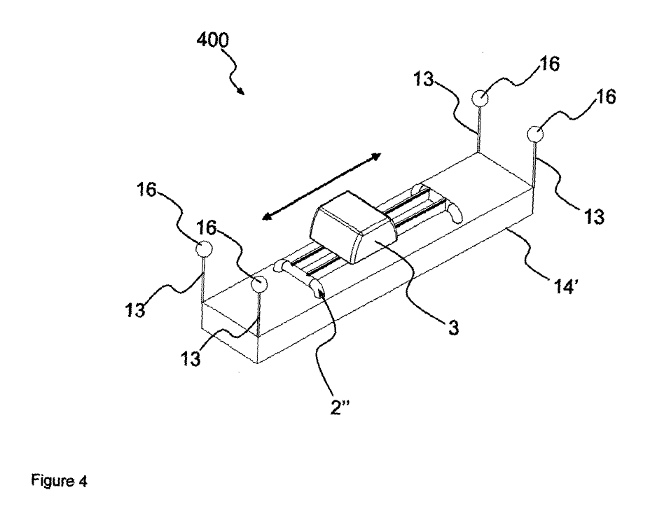

FIG. 4 illustrates a fourth embodiment of the invention;

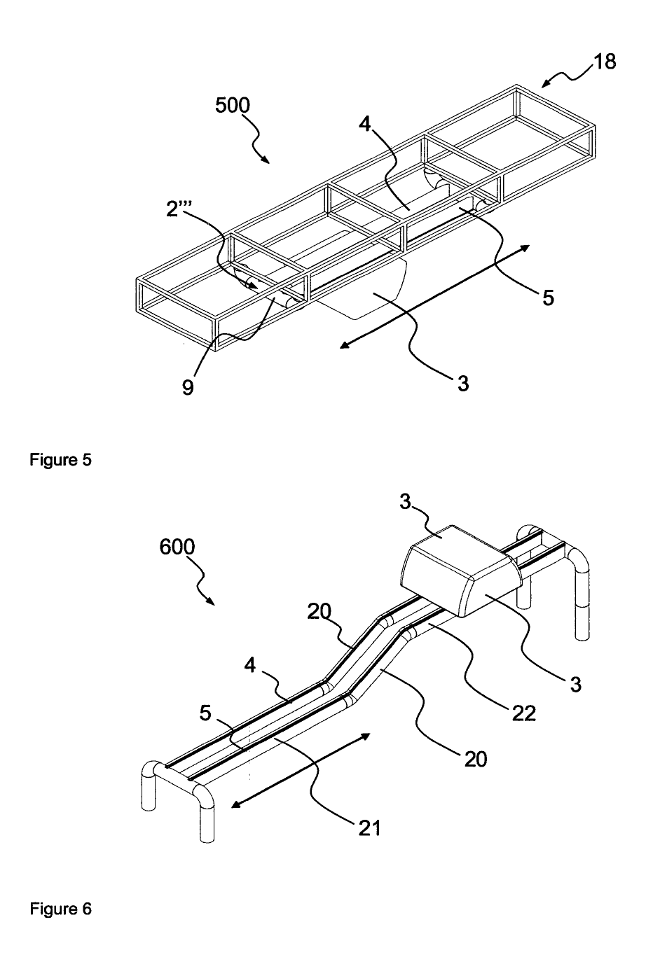

FIG. 5 illustrates a fifth embodiment of the invention; and

FIG. 6 illustrates a sixth embodiment of the invention.

FIG. 1 shows a first embodiment of apparatus 100 according to the invention. The apparatus 100 has a guide element 1, a support structure 2 and an energy capture element 3. The energy capture element 3 is a moving member that is acted upon and responds to movement and/or pressure changes (surges) in the body of water in which it sits.

In a wave configuration, the moving member or energy capture element 3 moves back and forth along the guide element 1 in use, propelled by the water motion and/or pressure surges, and this motion is absorbed, to be either converted into energy or to be dissipated locally.

In a wave and tidal or in a purely current-tidal configuration, the cross section with respect to the flow of the moving member is reduced when it reaches the downstream side of the guide element 1 by opening vents (not shown) on the moving member 3 using a mechanism (not shown) housed inside it. At this point, the moving member 3 is brought back to the upstream end of the guide element 1 by an active system (not shown) at the upstream end of the guide element 1, where the reduction in frontal area is reversed and a new energy extraction (or dissipation) cycle begins. In an alternative implementation of this embodiment, the moving member 3 has a reduced cross section when rotated with respect to the flow. In this alternative implementation, a mechanism housed on the moving member 3 or on the guide element 1 rotates the moving member 3 when it reaches the downstream end of the guide element 1 in order to reduce its frontal area. The moving member 3 is then returned to the upstream end of the guide element 1, rotated to a position that returns the frontal area to its initial, greater extent, and then a new cycle begins.

The capacity to reduce the flow cross section can also be used to adapt the device to the wave regime or to the tidal/current regime, so that if the waves are too energetic or the current flow is too fast or too turbulent or both the moving member can be given a reduced frontal area to be less affected by waves or currents or both, and when the waves or currents become less energetic, the cross section can be increased back.

The guide element 1 is formed by two parallel and linear beams 4, 5 supported at each end on the support structure 2, which holds the beams 4, 5 in linear arrangement. In this embodiment of the invention, the support structure 2 is formed from two end sections 6. Each end section comprises two leg elements 7, two corner elements 8 and a cross bar 9. These sections are joined to form a roughly U-shaped frame. The support structure 2 lies directly on the sea floor, or riverbed, and is kept at its position via its weight (gravity based mooring), anchors or harpoons or similar devices, or both. The parallel beams 4, 5 of the guide element 1 define a guide path along which the moving member 3 can move. The support structure 2 is positioned so that the guide path described by the moving member is a generally horizontal line.

The moving member 3 is positioned on top of two parallel and linear beams 4, 5 that make up the guiding member 1. A system with just one beam or more than two could equally well be used, with no specific advantage related to the working principle of the device in one versus the other solution. These beams 4, 5 are variable in length, depending on the range of motion required for the location, and they can have a fixed length for a given location or they could be made to vary their length depending on the wave regime.

The moving member 3 moves along the guide element 1 by means of wheels working in a way similar to those of a roller-coaster, but it could also use coasters or magnetic levitation or other forms of guide. In a basic version of this embodiment, the guide element 1 and the associated wheels are taken from one of the designs used in roller-coasters. The beams 4, 5 can be made of any suitable material, such as steel, and the wheels can be made of any suitable material, such as a plastic material possibly reinforced with steel. The beams 4, 5 can have any suitable sectional shape depending on the geometry of the wheel system used to attach to them (for example the section can be circular, or hexagonal, or it can be a T-shaped or H-shaped section like that of commercial steel profiles), and will typically extend for all the length of the support structure 2.

The support structure in a basic version of the embodiment could be made of steel profiles of any suitable sectional shape, welded together. The support structure can be just laid on the sea floor, keeping its position due to its weight, of if appropriate it can be bolted to the ground with various standard devices used normally to this end in underwater engineering.

The moving member 3 of the described embodiment is made of fiberglass, and has the general shape of a parallelepiped (although other shapes, like cylindrical or spherical ones, or a hydrofoil profile are possible). The shape influences the efficiency of the extraction, but any shape will result in energy absorption so no particular shape is needed to make the device work. If the moving member needs to have different cross sections at different angles, the parallelepiped may have a rectangular shape with one side significantly longer than the other, as shown in FIG. 1. If the moving member is a hydrofoil, the guide element will generally be transverse to the tidal flow (not necessarily at 90 degrees, especially in case a combined wave and tidal function is expected). The moving member 3 can be rigid, in the sense that its shape does not substantially change under the action of the waves. It is possible to have variations of the general structure of the device in which the shape of the moving member can be actively changed, to adapt it to the sea state (for example by changing its displacement or its cross section, or its profile especially in case of a hydrofoil shape, or any combination of these).

The apparatus 100 also includes a power transfer system, or power converter (not shown) arranged to extract and convert energy from the movement of the energy capture element 3 along the guide path. In this example, the power converter is an electro-mechanical device housed on the guide element 1, which converts the relative motion between the moving member 3 and the support structure 2 into electricity. Alternatively, the power converter could be a friction system included in the guide element 1, which dissipates energy in the form of heat. The power or energy transfer mechanism is not described in detail. It can be one of the known methods of converting relative movement of two bodies into energy or power. In a wave and tidal implementation, a system must be in place to drive the moving member upstream during half of the cycle, or another system must be in place to bring it back, like a system to invert the general force direction (for example if the guiding member is transversal to the flow and the moving member has a hydrofoil profile, a system to change the hydrofoil shape in order to redirect the resulting force).

For example, the power converter could comprise a belt and pulley power take off system, in which a belt is put into motion by the moving member and drives an electrical generator.

Although the power converter may preferably be housed in the guide element 1, in some variations of this embodiment it can be also housed on the support structure 2 or in the moving member 3. In this last case the large volume of the moving member (typically in the order of one cubic meter for each kilowatt of power to be extracted) will provide ample room to house this equipment. Alternatively, the power transfer system could be formed by a rack and pinion system, where the rack is fixed on the support structure and the pinion is attached to an electrical generator housed in the moving member. In this case, either the energy is dissipated or accumulated locally inside the moving member (for example via resistance dissipating it as heat or with a fuel cell producing chemicals from it and from the surrounding sea water and/or from a chemical precursor like freshwater or ammonia housed in the device), or it will be moved away from it through a cable or similar energy transport device. The power converter could include a different power take off system, based on rack and pinion system, belt, maglev or other or a magnetic dissipation device (like the ones used to slow down some types of roller-coasters). In the case of maglev suspension, the maglev system can be used to extract the energy.

FIG. 2 shows a second embodiment of apparatus 200 according to the invention. This embodiment is the same as apparatus 100, described above with reference to FIG. 1, with the variation that the depth of the guide element 1, and thus the moving member 3, can be varied. The variation in depth can be used to protect the moving member and the structure from excessive energy in the sea state or excessive tidal or current speed, or to follow a change in the depth of the sea at the installation site due to tides, or both. It could also be used to avoid collision with surface boats, or to be able to perform maintenance without the intervention of divers.

In a basic version of the system illustrated in FIG. 2, the variation of depth is obtained by replacing the fixed legs of the support structure 2 with composite legs 10, which are made of two coaxial cylinders (11, 12). The external cylinder 11 is fixed on the sea floor, and contains a hydraulic piston (not shown) which can push the internal cylinder 12 to a pre-determined elongation. The upper part of the support structure can be made to be negatively buoyant, so that gravity will push it down to balance the push of the hydraulic pistons. The hydraulic pistons can be connected to a common hydraulic pressure circuit and their valves can be regulated by a programmable logic controller (PLC) housed on board the system. In a variation (not shown) of this embodiment, the up and down movement could be provided and controlled through a rack and pinion system housed in each of the legs, actuated by electrical motors controlled again by a central PLC controller. Apparatus 200 is otherwise the same as apparatus 100 described above with reference to FIG. 1.

FIG. 3 shows a third embodiment of apparatus 300 according to the invention, which is suspended below the surface of the body of water and is moored to the sea floor, or riverbed. In this arrangement the support structure 2′ is positively buoyant, and kept at the operating depth by a mooring system 13, which can also possibly be regulated to change the operating depth in response to changes in the energy of the sea state or to changes in the depth of the water caused by tides or both. The guiding element could also have reduced section surface piercing components, used for example to stabilize its depth at a predetermined value. This version would be particularly indicated in rivers, or in areas at sea with very significant tidal ranges but reduced waves.

The positively buoyant support structure 2′ can be composed by a welded watertight steel structure 14, to which are welded the legs 7′ connected to the support structure of the guide element 1 (which is composed by two linear beams 4, 5 as in embodiment 1 or in embodiment 2). The rest of the structure can be exactly as in embodiment 1. The mooring on the sea floor is made of gravity bases connected to the floating structure through a standard tensioned mooring system. If the guide element is linked to the surface by surface piercing elements, the mooring lines can be slack and not taut. The length of the mooring lines connecting the structure 14 to the mooring weights (not shown) can be variable, so that the structure can be rotated or moved vertically or horizontally in the water column to adapt to the sea state (for example to take into account tides or to avoid excessive energy from storms) or to rotate the moving member and vary its cross section. Alternatively, the mooring system can be slack, so that in the case of waves the support structure reacts to the force received from the moving member (through the power interceptor components) via its displacement and inertia more than via its mooring lines. In this version of the present embodiment, the support structure will be long with respect to the wavelengths which are more interesting for energy transfer purposes, so that it will receive little overall resulting force from them (a length equal to half the wavelength would result in little or no total force). Also in this case by changing the length of the mooring lines the structure can be made to rotate or to change its average working depth. The rest of the arrangement is like the one represented in embodiment 1 and described above with reference to FIG. 1.

FIG. 4 shows a fourth embodiment of apparatus 400 according to the invention, which is suspended below and linked to the surface of a body of water. This version of the system is very similar to embodiment 3, but for the fact that in this arrangement the support (2″, 14′) of the guide element 1 is negatively buoyant, and kept at the operating depth through lines or cables connecting it to a system of surface piercing floaters or buoys 16. The operating depth can possibly be regulated by varying the length of the lines connecting the support structure 2″, 14′ to the floaters. There are also mooring lines (not shown in figure) connecting the structure to the sea floor, which in this case can be a slack mooring system. By acting on the mooring lines the whole structure can be made to rotate in the horizontal plane, to adapt to a changing direction of the waves. The rest of the arrangement is like the one represented in embodiment 1 and described above with reference to FIG. 1.

FIG. 5 shows a fifth embodiment of apparatus 500 according to the invention, which is suspended below the surface of the body of water and in which the moving member is underneath the support structure. In this arrangement the support structure 2′″ for the moving member 3 is positively buoyant so as to lie with its upper face 17 close to the surface (or slightly surface piercing) and the rest completely submerged. The moving member 3 is below the structure 2′″ and therefore always completely submerged. This embodiment can be obtained by taking embodiment 3, rotating it by 180 degrees along the main structure axis and including buoyancy elements in its platform 14 (see FIGS. 3 and 4). Alternatively (and as shown in FIG. 5), the support structure 2 comprises a latticed steel structure 18 provided with buoyancy elements (not shown) so as to be positively buoyant. Considerations on the mooring system are the same as for embodiment 3. The rest of the arrangement is like the one represented in embodiment 1 and described above with reference to FIG. 1.

FIG. 6 shows a sixth embodiment of apparatus 600 according to the invention, in which the guide path has a variable depth. In this arrangement, the beams 4, 5 of the guide element 1 are bent so that the guide path is divided along its length into two guide path sections 21, 22 that are collinear but vertically offset, so that they lie at different depths. A transition zone 20 connects the two sections 21, 22 at different depths. This arrangement allows the apparatus 600 to operate in two different regimes, where the moving member can be alternatively kept at a shallower depth (with less energetic sea states) or at a deeper one (with more energetic sea states). The remaining features of this embodiment can be exactly as those in embodiment 1. Variations of this embodiment can be made to resemble for the remaining features also embodiment 2, embodiment 3, embodiment 4 or embodiment 5 described above.

Some features of preferred embodiments of the invention are set out in the following numbered paragraphs:

1. An apparatus for intercepting energy from waves and from currents, comprising a water impacting moving member mounted on a guiding member, the water impacting member being allowed to move in a generally horizontal reciprocating motion along the guiding member under the action of waves and currents save for possible transition zones, the system further being capable of absorbing at least in part the energy associated to the reciprocating motion of the moving member while going in a downstream direction with respect to the flow determined by a wave or by the current, and further being capable of reducing flow impact to adapt to the its intensity or during a generally upstream motion along the guiding member needed in a type of cycle used for extraction from currents, so as to attain a final overall positive energy balance also from extraction from currents.

2. An apparatus as in paragraph 1, where the path determined by the guiding member is also slightly curved vertically or horizontally or both.

3. An apparatus as in paragraph 1 or 2, where there are transition areas along the guiding member where the moving member path is made to move from one generally horizontal direction to another which can be at a different depth.

4. An apparatus as in paragraph 1, 2 or 3, where a power transfer system housed on the apparatus uses electrical generators to absorb energy from the reciprocating motion of the moving member and convert it into electricity.

5. An apparatus as in paragraph 1, 2 or 3, where a power transfer system housed on the apparatus uses a hydraulic pump to convert the reciprocating motion of the moving member into pressurization of water, which is then dispersed or used locally or at a different location

6. An apparatus as in paragraph 1, 2 or 3, where a power transfer system housed on the device is a friction system converting the energy associated with the reciprocating motion of the moving member into heat.

7. An apparatus as in any of the preceding paragraph, where the guiding member comprises one or more guiding beams and the moving member has corresponding rolling components guiding the moving member over them.

8. An apparatus as in any of the preceding paragraphs, where the guiding member includes a magnetic levitation (maglev) device guiding the moving member over it.

9. An apparatus as in paragraph 8 where the maglev device is acting also as a power transfer device converting the energy associated with the reciprocating motion of the moving member into electricity.

10. An apparatus as in any of the preceding paragraphs, where the moving member remains rigid under the action of the waves.

11. An apparatus as in any of paragraphs 1 to 10, where the guiding member is supported on a positively buoyant structure either reaching the water surface or suspended in the water column and kept in its position by a combination of any of the following: the inertia originating from its mass; its displacement; links to weights possibly laying on the sea floor.

12. An apparatus as in any of paragraphs 1 to 10, where the guiding member is supported on a negatively buoyant structure either laid directly on the sea floor or suspended in the water column and kept in its position by a combination of any of the following: the inertia originating from its mass; its displacement; links to buoyant components possibly reaching the water surface.

13. An apparatus as in any paragraph claim, where the position of the guiding member inside the water column can be modified to adapt to the sea state.

14. An apparatus as in any preceding paragraph, where the orientation of the guiding member inside the water column can be modified to adapt to the sea state.

1. Apparatus for absorbing or converting energy from a moving body of water, the apparatus comprising an energy capture element which, in use, moves in response to movement of the body of water in which the energy capture element is placed, and an elongate guide element defining a guide path along which the energy capture element can move, wherein the energy capture element is a volume, and wherein, in use, the energy capture element and the guide element are arranged so that the energy capture element moves along the guide path in a substantially horizontal plane in response to differences in water pressure along a length of the energy capture element parallel to the guide path and in response to movement of the body of water surrounding the energy capture element.

2-29. (canceled)
